(19) United States
(12) Patent Application Publication
(10) Pub. No.: US 2004/0150390 A1
(43) Pub. Date: Aug. 5, 2004

(54) Rotational speed detector having outer wall molded with resin

(75) Inventors: Hiroyuki Tsuge, Nisshin-city (JP); Mitsuru Takasaki, Obu-city (JP); Mamoru Urushizaki, Chiryu-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/747,436

(22) Filed: Dec. 30, 2003

(30) Foreign Application Priority Data
Jan. 30, 2003 (JP) 2003-22562
Aug. 27, 2003 (JP) 2003-302535

(51) Int. Cl. G01P 3/48

(52) U.S. Cl. 324/174; 324/173; 73/493; 73/431

(57) ABSTRACT

A detector for detecting rotational speed of a vehicle wheel includes a detector element disposed in a housing and a lead wire for sending output signals of the detector element to an outside device. An output terminal of the detector element is electrically connected to the lead wire by tungsten inert gas welding. The housing and the lead wire are molded together with a resin material that forms an outer wall of the detector. Since the lead wire and the output terminal are connected by the tungsten inert gas welding, the junction is protected from any damages due to pressure and heat generated in the molding process.

### CROSS-REFERENCE TO RELATED APPLICATIONS

This application is based upon and claims benefit of priority of Japanese Patent Applications No. 2003-22562 filed on Jan. 30, 2003 and No. 2003-302535 filed on Aug. 27, 2003, the contents of which are incorporated herein by reference.

### BACKGROUND OF THE INVENTION

1. Field of the Invention

The present invention relates to a detector for detecting rotational speed of a rotating object, such as a wheel of an automotive vehicle.

2. Description of Related Art

An example of a rotational speed detector is disclosed in JP-A-2000-171475. In this detector, a sensor for detecting rotational speed of a rotating object and a lead wire for transmitting output signals of the sensor to an outside device. An output terminal of the sensor is connected to the lead wire via a metallic terminal plate. That is, the sensor terminal is connected to one end of the metallic terminal plate by soldering, and the lead wire is connected to the other end of the metallic terminal plate by staking.

Since the metallic terminal plate is interposed between the sensor terminal and the lead wire in the conventional detector, electrical connection has to be made at two points, i.e., at both ends of the metallic terminal plate. It is most desirable if the metallic terminal plate is eliminated and the sensor terminal and the lead wire are directly connected. However, if the lead wire and the sensor terminal are electrically connected by soldering as done in the conventional detector, the electrical connection would be damaged by heat and pressure imposed thereon when an outer wall of the detector is formed by molding a resin material.

### SUMMARY OF THE INVENTION

The present invention has been made in view of the above-mentioned problem, and an object of the present invention is to provide an improved rotational speed detector in which a sensor terminal is securely connected to a lead wire without using a terminal plate.

The rotational speed detector is composed of a housing having an open end, a detector element disposed in the housing, a lead wire for sending output signals of the detector element to an outside device, and a covering member for supporting and holding an end portion of the lead wire. An output terminal of the detector element is electrically connected to the end of the lead wire by TIG (tungsten inert gas) welding. After the lead wire and the output terminal are connected, an outer portion of the detector is molded with a resin material so that the covering member, the housing and the lead wire are connected together.

The resin material is also supplied to an inside space of the housing in the molding process. The junction connecting the lead wire and the output terminal is covered with the resin mold and firmly held therein. Since the lead wire and the output terminal are electrically connected by TIG welding, the junction is not damaged by heat and pressure imposed thereon in the molding process.

A capacitor for suppressing noise entering into the detector element through the lead wire may be used. In this case the capacitor lead is connected to the junction of the lead wire and the output terminal at the same time as the junction is formed by the TIG welding. The covering member supporting the end portion of the lead wire may be integrated with the housing. In this case the end portion of the lead wire is inserted into the open end of the housing and held therein.

A U-shaped portion may be formed on the lead wire in the vicinity of the junction connecting the lead wire to the output terminal. Since tensional force imposed on the junction in the molding process is absorbed by the U-shaped portion, the electrical connection between the lead wire and the output terminal is further securely maintained. A zigzag surface may be made on the outer surface of the end portion of the lead wire and/or on the U-shaped portion. The end portion of the lead wire is securely gripped in the resin mold by making the zigzag surface.

According to the present invention, the lead wire and the output terminal of the detector element are securely connected, and their junction is protected from any damages due to pressure and heat imposed thereon in the molding process. Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing a structure of mounting a rotational speed detector on a bearing of a wheel shaft of an automotive vehicle;

FIG. 2 is a cross-sectional view showing a rotational speed detector as a first embodiment of the present invention;

FIG. 3 is a cross-sectional view showing the rotational speed detector shown in FIG. 2, taken along line III-III in FIG. 2;

FIGS. 4A-4F sequentially show a process of manufacturing the rotational speed detector shown in FIG. 2;

FIGS. 5A-5C show a process of electrically connecting a detector terminal to a lead wire by micro-TIG welding;

FIG. 6 is a cross-sectional view showing a rotational speed detector as a second embodiment of the present invention;

FIG. 7 is a cross-sectional view showing the rotational speed detector shown in FIG. 6, taken along line VII-VII in FIG. 6;

FIG. 8 is a cross-sectional view showing a rotational speed detector as a third embodiment of the present invention;

FIG. 9 is a cross-sectional view showing a rotational speed detector as a fourth embodiment of the present invention;

FIG. 10 shows an end portion of a lead wire used in the rotational speed detector shown in FIG. 9, a U-shaped portion being formed;

FIGS. 11A-11G sequentially show a process of manufacturing the rotational speed detector shown in FIG. 9;

FIG. 12A shows a process of forming a zigzag surface on the U-shaped portion; and

FIG. 12B shows a lead wire, on an outer periphery of which a zigzag surface is formed.

### DETAILED DESCRIPTION OF THE PREFERRED EMBODIMENTS

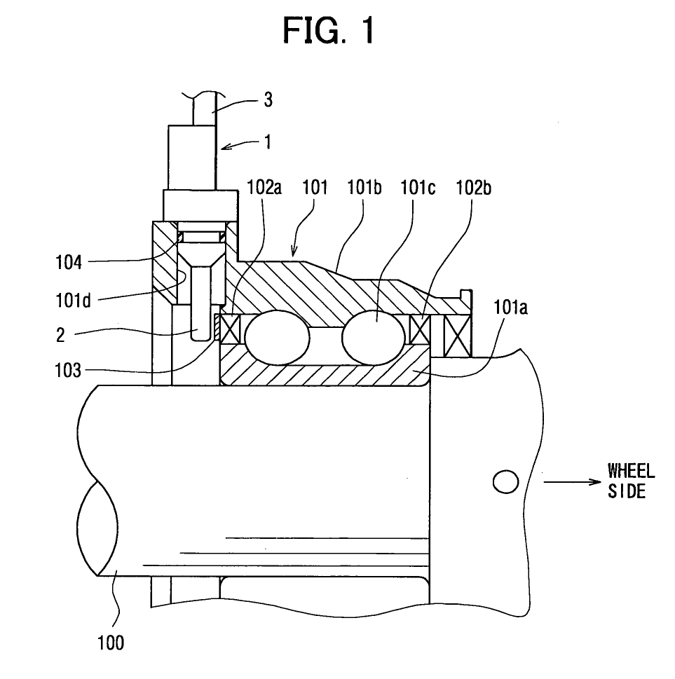

A first embodiment of the present invention will be described with reference to FIGS. 1-5C. A rotational speed detector 1 for detecting rotational speed of a wheel shaft 100 of an automotive vehicle is mounted on the wheel shaft as shown in FIG. 1. A bearing 101, which is composed of an inner ring 101a, an outer ring 101b and balls 101c disposed between the rings 101a, 101b, is mounted on the wheel shaft 100. The inner ring 101a is fixed to the wheel shaft 100 so that the inner ring 101a rotates together with the wheel shaft 100, and the outer ring 101b is fixed to a vehicle body. A pair of oil seals 102a, 102b are disposed at both axial ends of the bearing 101 so that grease filled in the bearing 101 is prevented from flowing out. On one of the oil seals, i.e., on the oil seal 102b, a magnetized ring 103 is attached so that the magnetized ring 103 rotates together with the inner ring 101a. The magnetized ring 103 is a annular ring surrounding the wheel shaft 100 and has plural S and N poles alternately magnetized.

A through-hole 101d is formed in the outer ring 101b, and the rotational speed detector 1 is inserted into the through-hole 101d and fixed thereto. The rotational speed detector 1 is positioned so that a detector element 2 contained in the detector 1 faces a side surface of the magnetized ring 103. An outer opening of the through-hole 101d is sealed with an O-ring 104 to keep the through-hole 101d water-tight. The detector element 2 is a single body molded with resin, and it includes an integrated circuit, which is composed of an MRE (a magnetoresistive element) that generates outputs responsive to changes in magnetic field intensity and a signal processor circuit, and an output terminal 21.

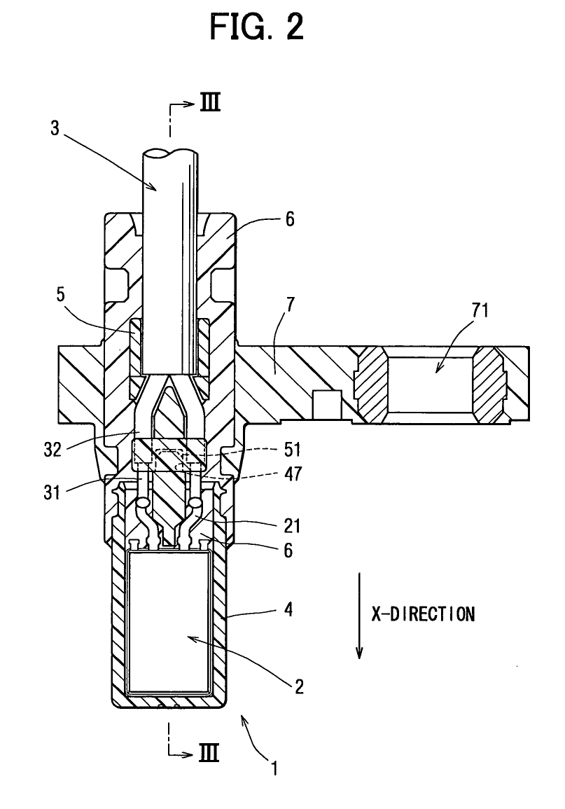

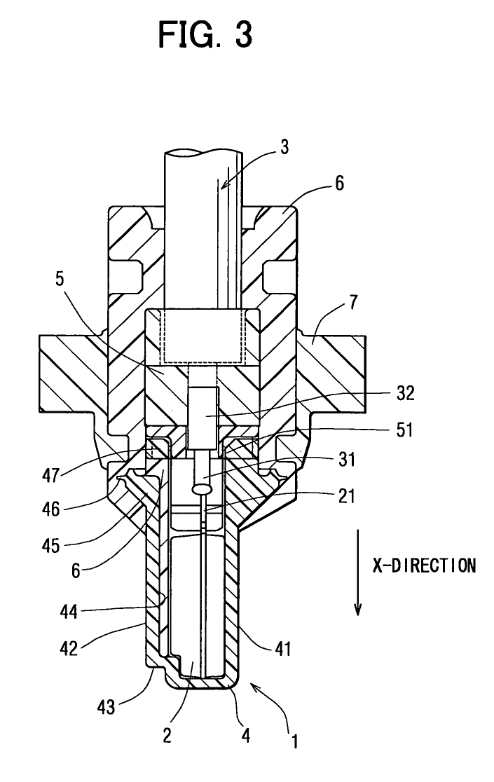

As shown in FIGS. 2 and 3, the detector element 2 is inserted into a housing 4 having one end closed and the other end open, in direction X shown in FIG. 2. The housing 4 has an elongate inner space having a rectangular cross-section. As shown in FIG. 3, a front surface of the housing 4 constitutes a detecting surface 41 that faces the magnetized ring 103, and a step 43 is formed at a bottom portion of a rear surface 42. Inside the rear surface 42, an elongate groove 44, which is filled with molded resin (explained later), is formed. The detector element 2 is contained in the housing 4 with a small clearance therebetween.

As shown in FIG. 3, a flange 45 extending in a direction perpendicular to X-direction from the detecting surface 41 and the rear surface 42 is formed. A projection 46 further projecting from the flange 45 is also formed. Further, projections 47, each formed in a rectangular pillar shape, extending upward from the detecting surface 41 and the rear surface 42 are disposed.

An output terminal 21 for sending the outputs of the detector element 2 to an outside device is extended upward from the detector element 2. A lead wire 3 for leading the output signals from the detector elements 2 to an outside device such as an ECU for controlling an ABS is electrically connected to the output terminal 21. The lead wire 3 includes a pair of insulated conductors, each composed of twisted plural fine wires. An end of each conductor includes a portion covered with an insulator (a covered portion 32) and a naked portion 31. The naked portion 31 is electrically connected to the output terminal 21 by TIG welding (tungsten inert gas welding, which is also referred to as micro-TIG welding). Either the end of the output terminal 21 or the end of the naked portion 31 is melted by the TIG welding. The end of the lead wire 3 is held and supported by a covering member 5, as shown in FIGS. 2 and 3. The covering member 5 and the housing 4 are connected by coupling a cutout 51 formed at a bottom portion of the covering member 5 to the projection 47 formed at an upper portion of the housing 4.

The detector element 2, the housing 4, the lead wire 3 and the covering member 5 are integrally connected by a resin mold 6. More particularly, an outside portion connecting the housing 4 and the covering member 5 is covered with the resin mold 6, and a portion connecting the output terminal 21 to the lead wire 3 is also covered with the resin mold 6. Further, the resin material forming the resin mold 6 is supplied in the molding process to the elongate groove 44 formed inside the rear surface 42. A stay 7 having a mounting hole 71 for mounting the rotational speed detector 1 on a vehicle is formed outside the resin mold 6.

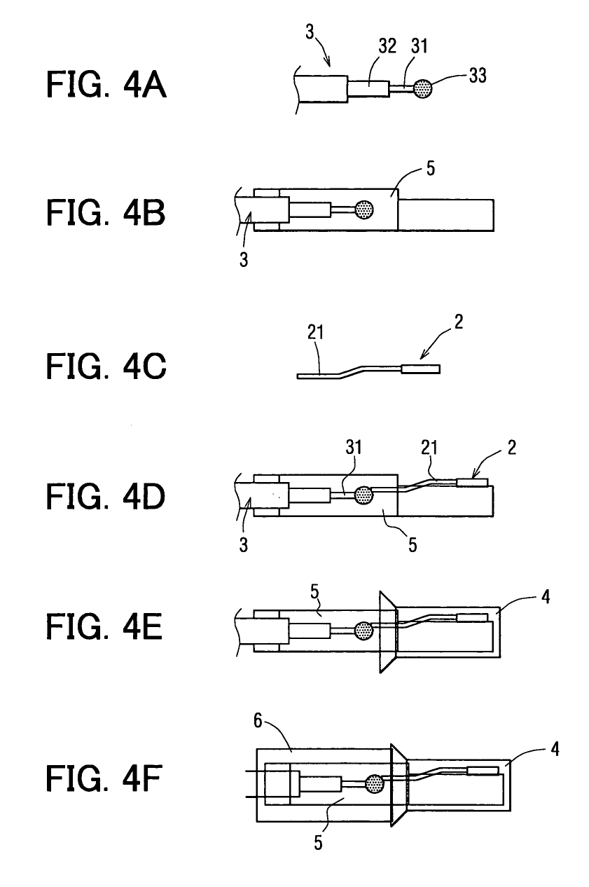

A process of manufacturing the rotational speed detector 1, particularly, a process of connecting the output terminal 21 to the lead wire 3, will be described with reference to FIGS. 4A-4F. As shown in FIG. 4A, an outer insulator of the lead wire 3 is removed to expose the covered portion 32 from the outer insulator. An insulator of the covered portion 32 is further removed to expose the naked portion 31 that is composed of twisted plural fine wires. A welded ball 33 is formed at the end of the naked portion 31 by the TIG welding. Then, as shown in FIG. 4B, the lead wire 3 having the welded ball 33 at its end is held by the covering member 5. On the other hand, as shown in FIG. 4c, the end of the output lead 21 led out from the detector element 2 is bent so that the end correctly abuts with the welded ball 33.

Then, as shown in FIG. 4D, the detector element 2 is held on the covering member 5 so that the end of the output lead 21 contacts the welding ball 33. The positions of the covering member 5, where the detector element 2 and the lead wire 3 are placed, are predetermined. The end of the output lead 21 and the welded ball 33 are connected by the TIG welding. It is also possible to support the detector element 2 on a jig, not on the covering member 5, in the process of the TIG welding. The TIG welding will be explained later in detail. The portion connecting the output lead 21 and the lead wire 3 is not covered with the covering member but is exposed.

Then, as shown in FIG. 4E, the detector element 2 is inserted into the housing 4, and the covering member 5 is connected to the housing 4 by coupling the cutout 51 of the covering member 5 to the projection 47 of the housing 4. Then, as shown in FIG. 4F, an outside of the portion where the covering member 5 and the housing 4 are connected is covered with the resin mold 6 formed by molding. In the molding process, the resin enters also into the housing 4 and inside the covering member 5, and thereby spaces inside the housing 4 and the covering member 5 are filled with the molded resin.

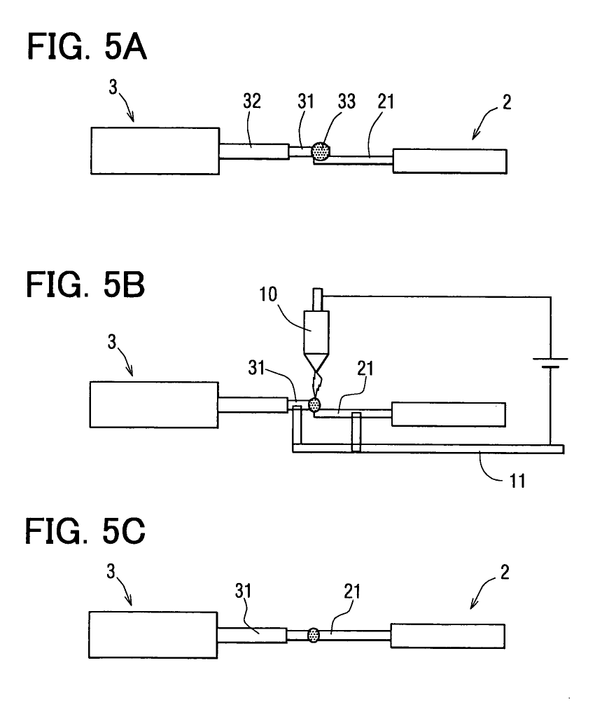

The process of TIG welding, or micro-TIG welding, will be explained with reference to FIGS. 5A-5C. As shown in FIG. 5A, the end of the output terminal 21 is overlapped with the welded ball 33. As shown in FIG. 5B, the naked portion 31 of the lead wire 3 and the output terminal 21 of the detector element 2 are connected to a grounding wire 11. Then, as shown in FIG. 5C, the overlapped portion is melted by a spark generated between a TIG welder 10 and the overlapped portion. It is also possible to melt only the welding ball 33 for making the connection between the output terminal 21 and the lead wire 3.

The following advantages are attained in the first embodiment described above. Since the output terminal 21 and the lead wire 3 are electrically connected by welding, the welded portion is not melted or damaged by heat and pressure generated in the molding process of forming the resin mold 6. Since the connection between the output terminal 21 and the lead wire 3 is made by the TIG welding, a welding rod used in a normal welding process is not required. Since the TIG welding tool 10 does not contact a point to be welded, the connecting process is easily performed.

Since the metallic terminal plate for connecting the lead wire 3 and the output terminal 21 used in the conventional detector is eliminated, the space for such terminal plate is saved and the manufacturing cost is lowered. Further, the welding process can be effectively performed by forming the welded ball 33 beforehand. Since the end portion of the lead wire 3 is covered and supported by the covering member 5 when the mold resin 6 is formed outside of the portion connecting the covering member 5 to the housing 4, the lead wire 3 does not move in the molding process, and therefore any possibility that the lead wire 3 is exposed to the outside of the resin mold 6 can be eliminated.

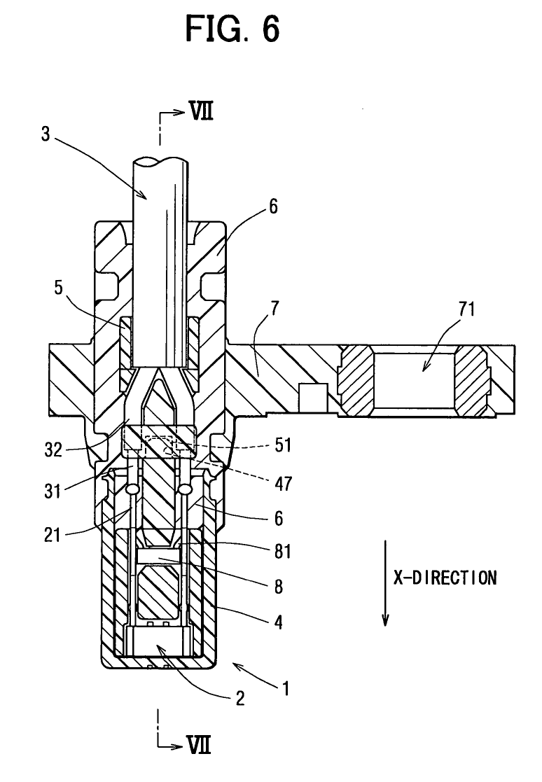

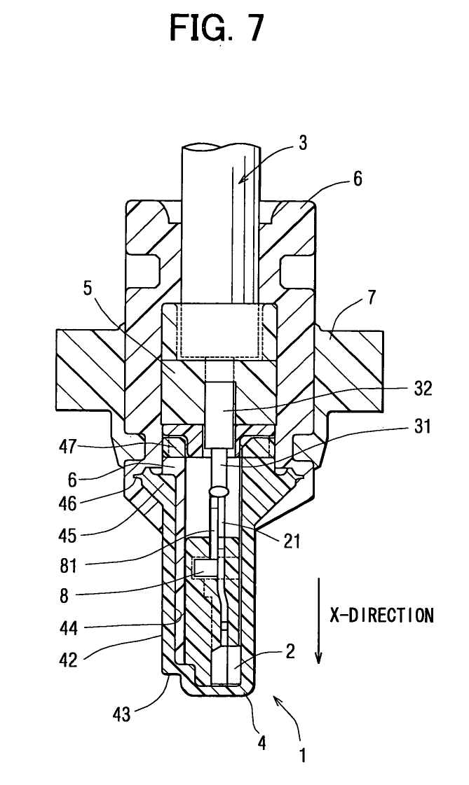

A second embodiment of the present invention will be described with reference to FIGS. 6 and 7. The second embodiment is similar to the first embodiment described above, but a capacitor 8 for suppressing outside noise entering into the detector element 2 through the lead wire 3 is provided and disposed in the housing 4. This capacitor 8 is used when an element for suppressing the noise is not integrated in the detector element 2.

As shown in FIGS. 6 and 7, the capacitor 8 is disposed in the housing 4 and positioned between the detector element 2 and the portion connecting the output terminal 21 and the lead wire 3. Capacitor leads 81 extend upward from the capacitor 8 in parallel to the output terminals 21. The end of each capacitor lead 81 is electrically connected to the same portion connecting the output terminal 21 and the naked portion 31 of the lead wire 3. The connection of the capacitor lead 81 is performed at the same time as the output terminal 21 is connected to the naked portion 31 of the lead wire 3.

By providing the capacitor 8, electromagnetic noise entering into the detector element 2 through the lead wire 3 is suppressed. Possible damages in the detector element 2 caused by the electromagnetic noise and possible malfunctions of the detector element 2 are avoided. Since the electrical connection of the capacitor leads is performed at the same time when the output terminal 21 is connected to the lead wire 3, the process of manufacturing the rotational speed detector 1 does not become complex by adding the capacitor 8.

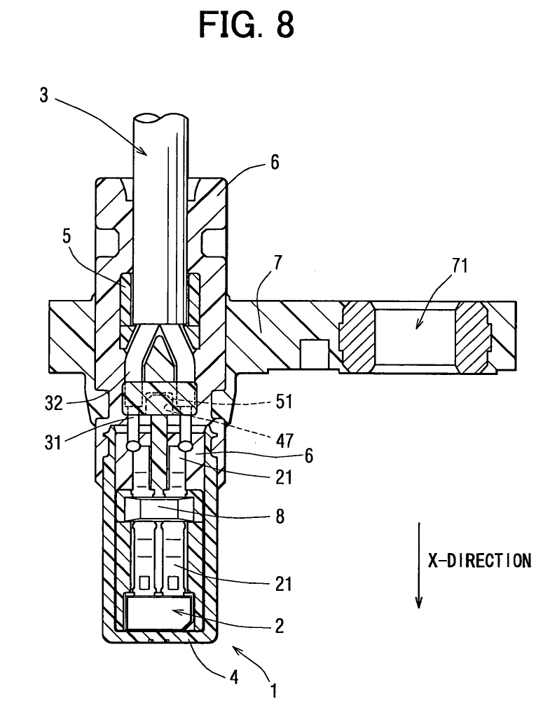

A third embodiment of the present invention will be described with reference to FIG. 8. The third embodiment is similar to the second embodiment described above, but the capacitor 8 is included in the output terminal 21. In other words, the output terminal 21 is modified so that it includes the capacitor 8 therein. In this manner, the process of connecting the capacitor lead 81 to the lead wire 3 can be eliminated.

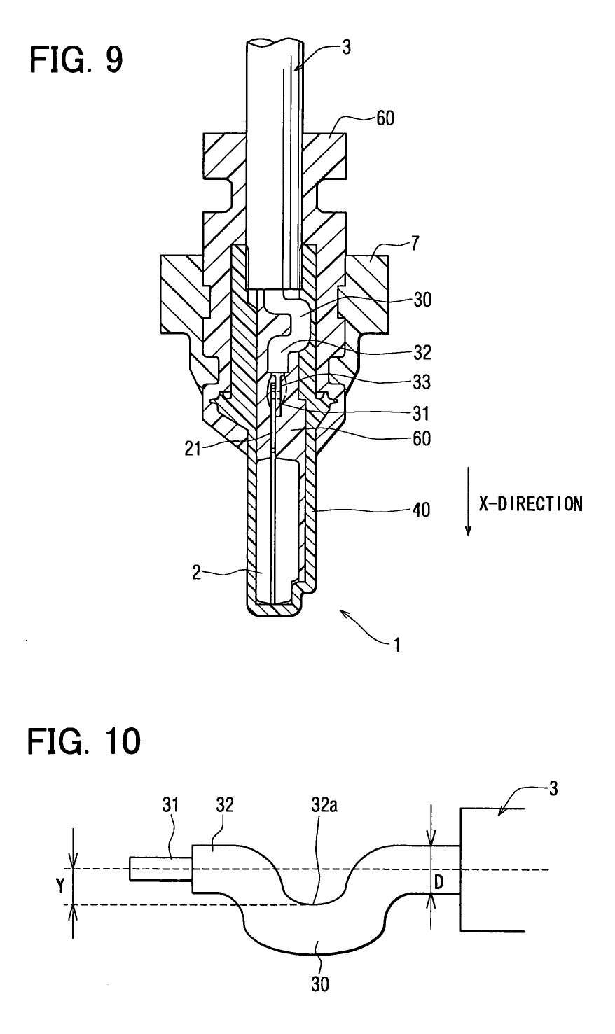

A fourth embodiment of the present invention will be described with reference to FIGS. 9-12B. In this embodiment, the housing 4 and the covering member 5, both used in the foregoing embodiments, are combined into a single body, i.e., a housing 40. The lead wire 3 is held by the housing 40 and includes a U-shaped portion 30. The U-shaped portion 30 is covered with a resin mold 60, the shape of which is modified from that of the resin mold 6 which is used in the foregoing embodiments. A portion of a resin material forming the resin mold 60 flows into the housing 40 in the molding process, thereby holding the U-shaped portion 30 and the portion connecting the lead wire and the output terminal 21 in the resin mold 60.

The U-shaped portion 30 is shown in FIG. 10 in an enlarged scale. The U-shaped portion 30 is formed by bending the covered portion 32 of the lead wire 3. An amount of bending, or a depth “Y” of the U-shaped portion 30 is set to satisfy the following relation with respect to a diameter “D” of the covered portion 32: 0.3 D≦Y≦1.2 D.

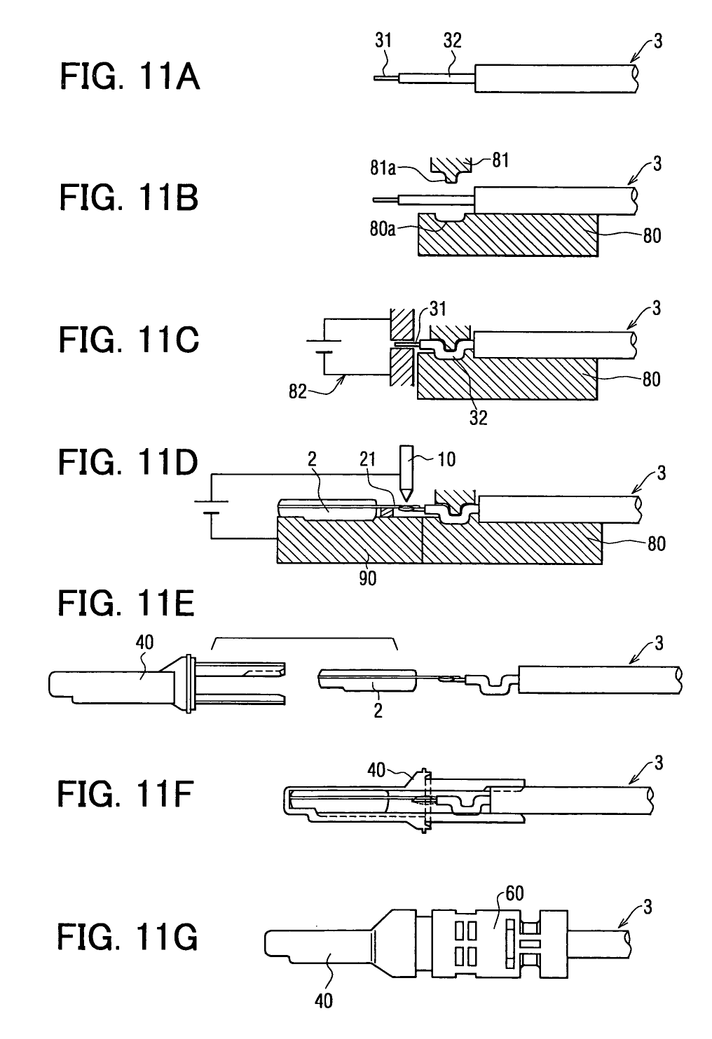

Referring to FIGS. 11A-11G, a process of manufacturing (particularly, a process of connecting the lead wire 3 to the output terminal 21) the rotational speed sensor 1 as the fourth embodiment of the present invention will be described. First, the insulator of the lead wire 3 is removed, as shown in FIG. 11a, exposing the naked portion 31 from the covered portion 32. Then, as shown in FIG. 11B, the lead wire 3 is placed between a pair of dies, an upper die 81 and a lower die 80. The upper die 81 has a projection 81a, and the lower die 80 has a depression 80a. Then, as shown in FIG. 11C, the U-shaped portion 30 is formed by pressing the covered portion 32 between the upper die 81 and the lower die 80. The pair of dies 80, 81 are formed so that the depth Y of the U-shaped portion is formed to satisfy the foregoing relation with respect to the diameter D of the covered portion 32, i.e., 0.3 D≦Y≦1.2 D. Then, the naked portion 31 of the lead wire 3 is subjected to resistance welding so that plural fine wires constituting the naked portion 31 are welded together.

Then, as shown in FIG. 11D, the detector element 2 is supported on a jig 90 so that the end of the output terminal 21 abuts or overlaps with the naked portion 31. The portion overlapping or abutting is welded by the micro-TIG welding, using the micro-TIG welder 10. Thus, the lead wire 3 and the output terminal 21 are electrically connected.

Then, as shown in FIG. 11E, the detector element 2 connected to the lead wire 3 is inserted into the housing 40 which is formed by resin-molding. As shown in FIG. 11F, the detector element 2 is held in the housing 40 and a portion of the lead wire 3 is also held in the housing 40. Then, as shown in FIG. 11G, an outer portion of the housing 40 and the lead wire 3, including a portion connecting both, is molded with a resin material, thereby forming the resin mold 60. The resin material forming the resin mold 60 also enters into the housing 40 in the molding process, and thereby the portion connecting the lead wire 3 and the output terminal 21 including the U-shaped portion 30 is firmly held in the resin mold 60.

It is possible to use the housing 4 and the covering member 5 (used in the embodiments 1-3) in place of the housing 40. In this case, the detector element 2 is held in the housing 4, and end portion of the lead wire 3 is held by the covering member 5. It is also possible not to cover the end portion of the lead wire 3 by the covering member 5 or the housing 40 and to directly mold it with the molding resin.

The following advantages are attained in the fourth embodiment described above. Since the U-shaped portion 30 is formed next to the junction of the naked wire 31 and the output terminal 21, a force imposed on the junction, in a direction pulling it, in the process of forming the resin mold 60 is well absorbed by the U-shaped portion 30. Therefore, the junction is prevented from being damaged in the molding process. The force pulling the junction is surely absorbed by the U-shaped portion 30 by forming the U-shaped portion 30 to satisfy the relation, 0.3 D≦Y≦1.2 D.

Since the end portion of the lead wire 3 is held by the housing 40 when the molding process for forming the resin mold 60 is performed, the lead wire 3 is prevented from being moved by the pressure generated in the molding process. Therefore, the lead wire 3 is kept at its position, and such a problem that the lead wire 3 is exposed to the outside of the resin mold 60 is surely avoided. Since the plural fine wires constituting the naked portion 31 are bonded together by resistance welding, the bonded portion can be easily and surely connected to the output terminal 21 by the micro-TIG welding.

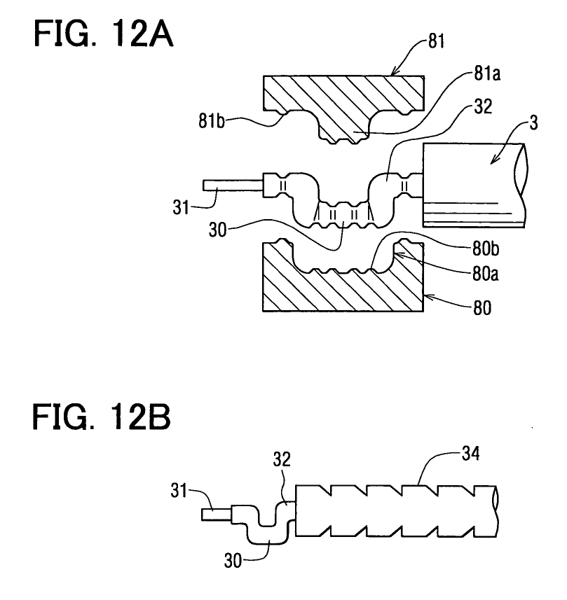

As shown in FIG. 12A, the insulator covering the U-shaped portion 30 may be formed in a zigzag surface by pressing it under heat. Small projections 80b and 81b are formed on the lower die 80 and the upper die 81, respectively, so that the surface of the U-shaped portion 30 is formed in a zigzag surface. As shown in FIG. 12B, the outer periphery 34 of the lead wire 3 may be formed in a zigzag surface. By forming the zigzag surface on the U-shaped portion 30 or the outer periphery 34 of the lead wire 3, the lead wire 3 can be further firmly held in the resin mold 60 because the resin material forming the resin mold 60 inters into depressions on the zigzag surface. Thus, the force imposed in the longitudinal direction on the junction connecting the lead wire 3 and the output terminal 21 is alleviated.

The present invention is not limited to the embodiments described above, but it may be variously modified. For example, a rotor having gears may be used in place of the magnetized ring 103 described above. Though the rotational speed detector 1 is positioned to face the magnetized ring 103 in its axial direction in the embodiments described above, the rotational speed detector 1 may be positioned to face the magnetized ring 103 in its radial direction. The present invention is applicable also to rotational speed detectors other than the detector that detects rotational speed of a vehicle wheel.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A rotational speed detector having an outer wall made of a resin mold, the rotational speed detector comprising:
a detector element having an output terminal; and
a lead wire for sending output signals of the detector element to an outside device, wherein:
the lead wire is connected to the output terminal of the detector element by micro-TIG welding.

2. The rotational speed detector as in claim 1, wherein:
the lead wire is composed of a plurality of twisted thin conductors; and
an end of the lead wire, at which the lead wire is connected to the output terminal, is welded before the lead wire is connected to the output terminal by the micro-TIG welding, so that the plurality of twisted thin conductors are connected to one another.

3. The rotational speed detector as in claim 1, wherein:
the rotational speed detector further includes an electronic component for reducing noise entering into the detector element through the lead wire, the electronic component having a conductor lead; and
the conductor lead of the electronic component is connected to a point where the lead wire is connected to the output terminal at the same time as the lead wire is connected to the output terminal.

4. The rotational speed detector as in claim 1, wherein:
the rotational speed detector further includes a housing in which the detector element is disposed and a covering member covering and supporting an end portion of the lead wire; and
a resin mold connecting the housing and the covering member into an integral unit is formed so that the resin mold covers at least a portion connecting the covering member to the housing.

5. The rotational speed detector as in claim 4, wherein:
a resin material forming the resin mold is supplied to an inner space of the housing and to an inner space of the covering member in a molding process of forming the resin mold; and
an end of the lead wire includes a U-shaped portion and the U-shaped portion is held within the resin mold.

6. The rotational speed detector as in claim 1, wherein:
the rotational speed detector further includes a housing in which the detector element is disposed and a resin mold connecting the lead wire and the housing;
the lead wire includes a U-shaped portion formed in the vicinity of a connecting junction where the lead wire is connected to the output terminal; and
the connecting junction and the U-shaped portion are positioned in the housing and covered with the resin mold.

7. The rotational speed detector as in claim 1, wherein:
the rotational speed detector includes a housing having an open end;
an end portion of the lead wire is inserted into the open end of the housing and held therein; and
the resin mold covers at least a vicinity of the open end of the housing.

8. The rotational speed detector as in claim 7, wherein:
a resin material forming the resin mold is supplied into an inner space of the housing in a molding process;
a junction connecting the lead wire and the output terminal is positioned in the housing; and
the lead wire includes a U-shaped portion formed in the vicinity of the junction, and the U-shaped portion is held within the resin mold.

9. The rotational speed detector as in claim 8, wherein:
an outer surface of the U-shaped portion is formed in a zigzag surface.

10. The rotational speed detector as in claim 8, wherein:
a depth Y of the U-shaped portion is set to satisfy the following relation: 0.3 D≦Y≦1.2 D, where D is an outer diameter of the lead wire forming the U-shaped portion.

11. The rotational speed detector as in claim 3, wherein:
the electronic component for reducing noise is a capacitor.

12. The rotational speed detector as in claim 7, wherein:
the end portion of the lead wire inserted into the open end of the housing and held therein has a zigzag outer surface.
